(19) United States
(12) Patent Application Publication
(10) Pub. No.: US 2007/0218435 A1
(43) Pub. Date: Sep. 20, 2007

(54) Law firm management training method

(76) Inventor: Richard W. Charette, Las Vegas, NV (US)

Correspondence Address: WEISS & MOY PC, 4204 NORTH BROWN AVENUE, SCOTTSDALE, AZ, 85251, US

(21) Appl. No.: 11/376,577

(22) Filed: Mar. 16, 2006

(51) Int. Cl. G09B 19/00

(52) U.S. Cl. 434/219

(57) ABSTRACT

A law firm management training method. In a multi-step process, lawyers and non-lawyers may be trained regarding ethical rules governing business relationships between lawyers and non-lawyers. Trainees may be educated regarding prohibited and permitted activities in such a relationship. Also as part of this training, instruction may be given regarding forms of agreement that may be permitted for a business relationship between a lawyer/law firm and a non-law management entity. Such training may occur in a live seminar setting, via audio or video tape, or may be delivered during an in-person solicitation.

### FIELD OF THE INVENTION

The present invention relates generally to the management of law firms and. more particularly, to the training of lawyers and non-lawyer management entities to enable a non-lawyer management entity to manage a law practice in a manner that is consistent with applicable legal rules.

### BACKGROUND OF THE INVENTION

In most jurisdictions in the United States, the ownership of any portion of a law practice by a non-lawyer is prohibited. For example, Rule 5.4 of the Model Rules of Professional Conduct generally prohibits a lawyer from sharing fees with a non lawyer, from forming a partnership with a nonlawyer, or from allowing a nonlawyer to own any interest in a professional corporation or association in which the lawyer is practicing. State rules based upon or similar to Model Rule 5.4 have generally been a barrier to the acquisition of an ownership interest in a law practice by non-lawyers.

On the other hand, the operation of a successful law practice nearly always requires the utilization of the skills of non-lawyer professionals, including secretaries, paralegals, office managers, and others. Moreover, the operation of a law practice involves business skills that many lawyers may not possess, including those relating to the hiring, management and firing of non-legal staff; billing and other financial issues; the securing of suitable office space, etc.

A need exists for a method for educating lawyers and non-lawyers about methods by which non-lawyers can undertake the management of a law firm, without violating any applicable ethical rules. The present invention satisfies these needs and provides other, related, advantages.

### SUMMARY OF THE INVENTION

In accordance with one embodiment of the present invention, a law firm management training method is disclosed. The method comprises: training at least one person regarding ethical rules applicable to a business relationship between a lawyer and a non-lawyer; identifying for the person at least one prohibited activity in a business relationship between a lawyer and a non-lawyer; identifying for the person at least one permitted activity in a business relationship between a lawyer and a non-lawyer; and training the person regarding a permitted form of agreement governing a business relationship between a lawyer and a non-lawyer.

In accordance with another embodiment of the present invention, a law firm management training method is disclosed. The method comprises: training at least one person regarding ethical rules applicable to a business relationship between a lawyer and a non-lawyer; identifying for the person at least one prohibited activity in a business relationship between a lawyer and a non-lawyer; identifying for the person at least one permitted activity in a business relationship between a lawyer and a non-lawyer; and training the person regarding a permitted form of agreement governing a business relationship between a lawyer and a non-lawyer; wherein at least one of the training steps occurs at a live seminar; and wherein the agreement is a service agreement.

In accordance with a further embodiment of the present invention, a law firm management training method is disclosed. The method comprises: training at least one person regarding ethical rules applicable to a business relationship between a lawyer and a non-lawyer; identifying for the person at least one prohibited activity in a business relationship between a lawyer and a non-lawyer; identifying for the person at least one permitted activity in a business relationship between a lawyer and a non-lawyer; training the person regarding a permitted form of a first agreement governing a business relationship between a lawyer and a non-lawyer; wherein at least one of the training steps occurs in the form of a sales solicitation; wherein the first agreement is a service agreement; and training the person regarding a permitted form of a second agreement governing a business relationship between a lawyer and a non-lawyer; wherein the second agreement is one of a loan agreement and a lease; and wherein at least one of the training steps includes the use of written materials.

### BRIEF DESCRIPTION OF THE DRAWINGS

FIG. 1 is a flow chart, illustrating steps in a training method consistent with an embodiment of the present invention.

### DETAILED DESCRIPTION OF THE PREFERRED EMBODIMENTS

The present invention is concerned with a method for training lawyers and/or non-lawyer professionals regarding methods by which a non-lawyer professional can become a manager of a law practice, in a manner consistent with applicable ethical rules.

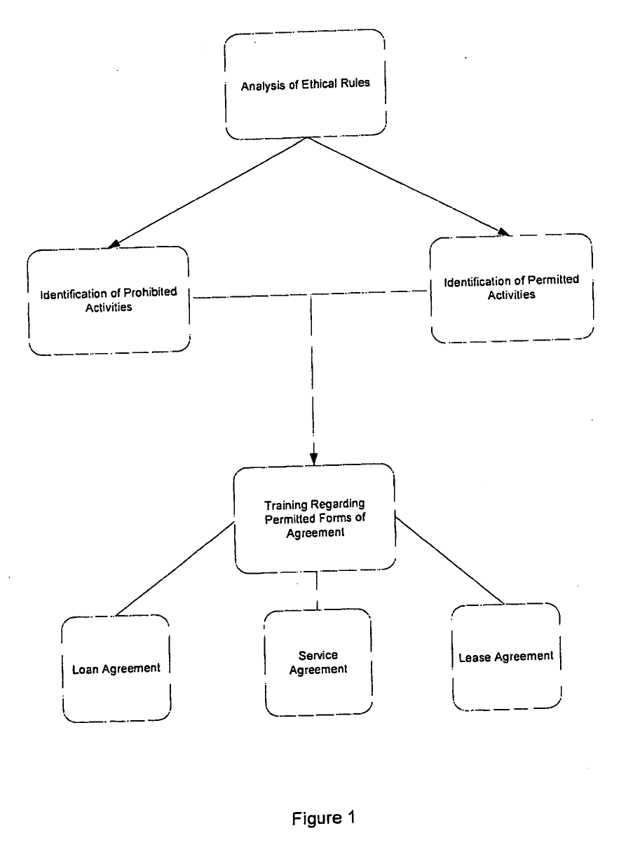

Referring first to FIG. 1, a step in the practicing of the present invention is to train lawyers and non-lawyer professionals regarding any applicable ethical rules that may restrict the business relationship between lawyer and non-lawyer. These would include rules such as Model Rule 5.4 noted above, prohibitions on the sharing of legal fees with non-lawyers and other rules. Trainees should be given a clear understanding regarding the role that non-lawyers can play i.e., law firm management and the role that they cannot play i.e., law firm ownership or fee-splitting. Preferably, any such training should qualify for Continuing Legal Education credit for lawyers who participate in such training.

Still referring to FIG. 1, once the trainees have received an analysis of applicable ethical rules, they may be taught about prohibited activities; i.e., any applicable prohibitions on non-lawyer ownership of a law firm, fee splitting with non-lawyers, non-lawyer management of a legal case, retention of legal records by a non-lawyer, or the like. Conversely, trainees should be given an understanding regarding permitted activities by a non-lawyer, including the ability to provide marketing services, the ability to provide administrative support, the ability of an accountant to hold trust accounts, and the like.

As illustrated in FIG. 1, once trainees have been given an analysis of applicable ethical rules and have had identified for them prohibited and permitted activities, attention may turn to training regarding permitted forms of agreement between a law firm and a management entity, regarding the management by that entity of the law firm's practice. In one embodiment, trainees are taught about the possible terms of a service type of agreement between a law firm and a management entity, and may even be provided with a form of agreement. The kinds of provisions that may be present in such an agreement could include:

(a) a description of services to be provided by the non-lawyer management entity, including one or more of the following:
1. The provision of accounting and related financial support services required in connection with the operation of a legal office;
2. Maintenance of the law firm's office space;
3. The furnishing to the law firm of office supplies;
4. Billing and collection services;
5. Hiring, firing, training, and management of support personnel;
6. Preparation of marketing materials for the law firm;

(b) the compensation for the management entity and/or the law firm, including timing requirements for payments by the law firm to the management entity;

(c) the respective rights of the law firm and management entity, including:
1. The law firm shall be solely responsible for determining all charges and fees for its professional services;
2. Any prohibition on the receipt by the management entity of payments directly from clients or third party payers;

(d) any requirement of exclusivity between the management entity and the law firm (e.g., a prohibition on the law firm engaging a different management entity during the tern of the agreement to provide services that the management entity has contracted to provide);

(e) the use by the law firm of any particular service-mark/firm name, particularly where the applicable jurisdiction permits a law firm to utilize a service-mark; and

(f) non-disclosure provisions; and

(g) other provisions governing the relationship, as desired.

The training may also incorporate methods by which the relationship between a law firm and a management entity may be expanded to include, for example, the loaning of money by the management entity to the law firm. In this fashion, the management entity, in addition to its other tasks, can fulfill a function that may have previously been fulfilled by a bank credit line, or the like. The training may include the provision of a form of promissory note that may be utilized.

In one embodiment, a promissory note between a law firm and a management entity may be secured. Accordingly, it may be desired to further include, as part of the training process, dissemination of a draft security agreement. The type of collateral that may be included in such an agreement may include tangible assets owned by the law firm, such as furniture and office equipment, in addition, where not barred by applicable ethical rules, the agreement may further include as security accounts receivables, documents, instruments, accounts, etc.

In one embodiment, the training will also treat the possible creation of a landlord/tenant (tenant/subtenant) relationship between the management entity and the law firm. Where the management entity owns office space, or is a tenant with the right to sublease with respect to office space, the parties may desire to enter into a lease agreement. Such an arrangement can help the law firm avoid the burden of locating suitable office space, as well as the possible expense of finishing such space, negotiating a long-term lease, etc.

The training as herein described may occur in the form of one or more presentations at a live seminar. Training may also be conducted utilizing audio and/or video recordings, as well as written training materials. Training may also occur in the form of a sales solicitation by the management entity, or an agent acting on its behalf, to the law firm, or an agent acting on its behalf.

While the invention has been particularly shown and described with reference to the preferred embodiments thereof, it will be understood by those skilled in the art that the foregoing and other changes in form and details may be made therein without departing from the spirit and scope of the invention.

For example, the method of the present invention may be used with professionals and/or firms in fields other than the legal fields, where there might be ethical or similar restrictions on business relationships with persons or entities who are not also a member of the profession. By way of example only, there may be application to the medical field, the accounting field, etc.

I claim:

1. A law firm management training method comprising:
training at least one person regarding ethical rules applicable to a business relationship between a lawyer and a non-lawyer;
identifying for the person at least one prohibited activity in a business relationship between a lawyer and a non-lawyer;
identifying for the person at least one permitted activity in a business relationship between a lawyer and a non-lawyer; and
training the person regarding a permitted form of agreement governing a business relationship between a lawyer and a non-lawyer.

2. The method of claim 1 wherein the agreement is a service agreement.

3. The method of claim 2 further comprising the step of training the person regarding a permitted form of a second agreement governing a business relationship between a lawyer and a non-lawyer.

4. The method of claim 3 wherein the agreement is a loan agreement.

5. The method of claim 4 wherein the loan agreement is secured.

6. The method of claim 3 wherein the agreement is a lease agreement.

7. The method of claim 1 wherein at least one of the training steps occurs at a live seminar.

8. The method of claim 1 wherein at least one of the training steps occurs via an audio recording.

9. The method of claim 1 wherein at least one of the training steps occurs via a video recording.

10. The method of claim 1 wherein at least one of the training steps occurs in the form of a sales solicitation.

11. The method of claim 1 wherein at least one of the training steps includes the use of written materials.

12. A law firm management training method comprising:
training at least one person regarding ethical rules applicable to a business relationship between a lawyer and a non-lawyer;
identifying for the person at least one prohibited activity in a business relationship between a lawyer and a non-lawyer;
identifying for the person at least one permitted activity in a business relationship between a lawyer and a non-lawyer; and
training the person regarding a permitted form of agreement governing a business relationship between a lawyer and a non-lawyer;
wherein at least one of the training steps occurs at a live seminar; and
wherein the agreement is a service agreement.

13. The method of claim 12 further comprising the step of training the person regarding a permitted form of a second agreement governing a business relationship between a lawyer and a non-lawyer.

14. The method of claim 13 wherein the agreement is a loan agreement.

15. The method of claim 14 wherein the loan agreement is secured.

16. The method of claim 13 wherein the agreement is a lease agreement.

17. The method of claim 12 wherein at least one of the training steps occurs via a video recording.

18. The method of claim 12 wherein at least one of the training steps occurs in the form of a sales solicitation.

19. The method of claim 1 wherein at least one of the training steps includes the use of written materials.

20. A law firm management training method comprising:
training at least one person regarding ethical rules applicable to a business relationship between a lawyer and a non-lawyer;
identifying for the person at least one prohibited activity in a business relationship between a lawyer and a non-lawyer;
identifying for the person at least one permitted activity in a business relationship between a lawyer and a non-lawyer;
training the person regarding a permitted form of a first agreement governing a business relationship between a lawyer and a non-lawyer;
wherein at least one of the training steps occurs in the form of a sales solicitation;
wherein the first agreement is a service agreement; and
training the person regarding a permitted form of a second agreement governing a business relationship between a lawyer and a non-lawyer;
wherein the second agreement is one of a loan agreement and a lease; and
wherein at least one of the training steps includes the use of written materials.

21. A professional firm management training method comprising:
training at least one person regarding ethical rules applicable to a business relationship between a member of a profession and a non-member of the profession;
identifying for the person at least one prohibited activity in a business relationship between a member of a profession and a non-member of the profession;, identifying for the person at least one permitted activity in a business relationship between a member of a profession and a non-member of the profession; and
training the person regarding a permitted form of agreement governing a business relationship between a member of a profession and a non-member of the profession.
